(19) United States
(12) Patent Application Publication
(10) Pub. No.: US 2023/0160123 A1
(43) Pub. Date: May 25, 2023

(54) METHOD AND WASHING MACHINE

(71) Applicant: Miele & Cie. KG, Gütersloh (DE)

(72) Inventors: Rainer BICKER, Verl (DE); Markus DRÜCKER, Gütersloh (DE); Benedikt FECHTEL, Rheda-Wiedenbrück (DE); Magnus KORTENJANN, Telgte (DE); Steffen LASNER, Borgholzhausen (DE); Dirk SIEDING, Lünen (DE); Marcel ZIELKE, Ennigerloh (DE)

(21) Appl. No.: 17/915,601

(22) PCT Filed: Mar. 22, 2021
(86) PCT No.: PCT/EP2021/057262

§ 371 Date: Sep. 29, 2022

(30) Foreign Application Priority Data
Mar. 30, 2020 (DE) 10 2020 108 734.9

(51) Int. Cl. D06F 33/36; D06F 35/00; D06F 39/08

(52) U.S. Cl. CPC D06F 33/36; D06F 35/006; D06F 39/083; D06F 39/087; D06F 2103/04

(57) ABSTRACT

A washing machine and method for operating a washing machine having a suds container for holding water, a non-ribbed drum rotatably mounted in the suds container for holding laundry, a motor for driving the drum, and an open or closed loop control device. The method allows the execution of a washing program (Wp) having a washing phase (Wa) and/or at least one rinsing phase (Sp), and includes feeding water into the suds container in a first region of the drum in at least one of these phases (Wa, Sp) up to a predetermined water level (h) that is selected such that the laundry floats in the water, and rotating the drum at a predetermined rotational speed such that water is released from a second region of the drum and falls onto the laundry.

### RELATED APPLICATIONS

The present disclosure claims priority to and the benefit of PCT Application PCT/EP2021/057262, filed on Mar. 22, 2021, which claims priority to and the benefit of German Application 10 2020 108 734.9, filed on Mar. 30, 2020, the entire contents of which are incorporated herein by reference.

### TECHNICAL FIELD

The disclosure relates to a method for operating a washing machine and to a washing machine. In particular, the disclosure relates to execution of a washing program having a washing phase and/or at least one rinsing phase, and a correspondingly designed washing machine, where information on position and direction relates to an operational set-up position of the washing machine.

### BACKGROUND

In a washing machine, the rinsing effect can be improved by sprinkling the laundry from above, for example during a rinsing phase, since this supports the liquor exchange. A better liquor exchange means that detergent is rinsed out of the laundry faster and more thoroughly. In washing machines having ribbed drums, a circulation system is necessary to allow sprinkling of the laundry. The circulation system includes a circulation pump, a tube, and a nozzle. The circulation pump sucks the water out of the sump of the washing machine. The water is then pumped through the tube to the nozzle that is positioned such that the laundry is sprayed with water from above. The circulation system involves additional production costs.

### SUMMARY

The disclosure addresses the problem of providing a method for operating a washing machine and providing a washing machine that allow a cost-effective sprinkling of the laundry.

According to the disclosure, this problem is solved by a method having the features of claim 1 and by a washing machine having the features of claim 9. Advantageous embodiments and developments of the disclosure can be found in the subsequent sub-claims.

The advantages that can be achieved with the disclosure, in addition to the opportunity of effectively sprinkling the laundry and the associated better washing and/or rinsing effect, are their cost-effectiveness. No circulation system is required, which saves components and thus costs.

The disclosure relates to a method for operating a washing machine having a suds container for holding water, a non-ribbed drum rotatably mounted in the suds container for holding laundry, a motor for driving the drum, and an open or closed loop control device, wherein the method allows the execution of a washing program having a washing phase and/or at least one rinsing phase, the method comprising the following steps:

feeding water into the suds container and a first region of the drum in at least one of these phases up to a predetermined water level that is selected such that the laundry floats in the water, and

rotating the drum at a predetermined rotational speed such that water is released from a second region of the drum and falls onto the laundry.

The disclosure is based on the basic idea that the washing machine has a non-ribbed drum and that the predetermined rotational speed is adjusted at the predetermined water level such that the water is entrained in a gap between the suds container and the drum by the rotation of the drum to such an extent that water located in the first region is guided to the second region by the rotational motion and there is released from the drum and falls onto the laundry. This is only possible due to the fact that there are no ribs in the drum which, if present, cause the laundry to execute a rotational motion. In addition, it is advantageous that the water level reaching into the drum is selected such that the laundry can float. As a result, friction between the drum casing and the laundry is eliminated and the laundry is not caused to execute a rotational motion by the rotation of the drum but remains substantially in the same position. If this method is executed using a washing machine having a drum with ribs, the drum cannot slide under the floating laundry. The laundry is entrained by the ribs and lies in contact with the drum casing. Sprinkling the laundry from above is therefore not possible when using a drum having ribs.

A non-ribbed drum is a drum that does not have any ribs or entraining elements inside it. However, it can have other elevations and/or depressions that do not have the shape of the plate-shaped rib or entraining element. The drum, preferably the drum casing, preferably has depressions and/or elevations other than a rib. It preferably has honeycombs, each of which is designed as an elevation or a depression.

The water preferably falls drop-wise from the second region onto the laundry. As a result, the laundry is sprinkled and/or sprayed with water.

The laundry is preferably located at least partially in the first region. The second region is preferably the region of the drum in which the water entrained in the gap between the suds container and the drum by the rotation of the drum is released and falls onto the laundry located in the first region of the drum. In a preferred embodiment, the first region is the lower region, and the second region is the upper region, based on an operational set-up position of the washing machine.

Preferably, the drum is circular in cross section, the first region is a region of the drum between a 5 and a 7 o'clock position, and the second region is a region of the drum between a 12 and a 2 o'clock position, more preferably at about a 1 o'clock position and/or between a 10 and a 12 o'clock position, more preferably at about an 11 o'clock position when viewed in the circular cross section. The first region between a 5 and a 7 o'clock position is to be understood in this case such that an axis of rotation running through a centre of the drum that is circular in cross section corresponds analogously to the pivot point of the hands of a clock. The first region between a 5 and a 7 o'clock position thus designates the corresponding region in the lower half of the drum when viewed from the front from the direction of a loading opening of the washing machine having the axis of rotation of the drum as the centre. The second region between a 12 and a 2 o'clock position and/or between a 10 and a 12 o'clock position accordingly corresponds to the corresponding region in the upper half of the drum. More preferably, the second region is the region of the drum between the 12 and the 2 o'clock positions, more preferably at about the 1 o'clock position.

In a preferred embodiment, steps a) and b) are executed in at least one of the at least one rinsing phase. This supplies an effective rinsing effect in a cost-effective manner.

Before execution of the washing phase and/or at least one rinsing phase, a detection phase is preferably executed in which a load amount of laundry in the drum is detected, and step b) is executed as a function of the detected load amount. This has the advantage that it can be ensured that the laundry can float in the water level. In step a), an amount of water is preferably supplied that depends on the detected load amount.

Step b) is preferably executed when the load amount is below a predetermined limit value. The limit value is preferably selected such that floating, preferably complete floating, of the laundry is made possible in step b). If the load amount is too large such that floating cannot take place due to a lack of space, for example, step b) is not executed. If the load amount is such that floating can take place, step b) is executed.

In a preferred embodiment, the predetermined limit value depends on a type of laundry, which is determined by selecting the washing program. Different washing programs such as cotton, delicates, wool washing programs are usually stored in a washing machine, which programs are provided and/or recommended for different textile types such as cotton, silk, or woolen textiles and from which a user selects one before starting a washing program. Depending on the type of laundry, the predetermined limit value is preferably in the range of 1 to 7 kg, preferably 2 to 5 kg.

The predetermined rotational speed is preferably in the range of 70 and 180 rpm or 90 to 110 rpm. At these rotational speeds, the second region is at the top of the drum, in particular between the 12 and the 2 o'clock positions and/or between the 10 and the 12 o'clock positions when the first region is at the bottom of the drum.

The disclosure also relates to a washing machine having a suds container for holding washing liquid, a non-ribbed drum rotatably mounted in the suds container for holding laundry, a motor for driving the drum, and an open or closed loop control device that is designed to execute a method according to one or more of the embodiments described above.

Embodiments and advantages described for the method apply correspondingly to the washing machine and vice versa.

The washing machine can be a front loader or a top loader. The term “washing machine” also comprises a combination device such as a washer-dryer. The drum is preferably mounted in the suds container so that it can rotate horizontally.

The open or closed loop control device can be designed in one or more parts. In addition to regulating the rotational speed of the motor for driving the drum, it has other open or closed loop control means that are required to execute the washing program.

In a preferred embodiment, the washing machine is free of any circulation system. In other words, the washing machine in particular does not have the above-described circulation system, which is designed to suck water out of the sump by means of the circulation pump and then to pump it through the tube to the nozzle that is positioned such that the laundry is sprayed with water from above. A circulation system of this type is superfluous for the washing machine according to the disclosure.

### BRIEF DESCRIPTION OF THE DRAWINGS

An embodiment of the disclosure is shown in the drawings in a purely schematic manner and will be described in more detail below. In the drawings, schematically and not to scale:

FIG. 1 is a partial cross-sectional view of a washing machine according to the disclosure; and

FIG. 2 shows a washing program stored in the washing machine shown in FIG. 1 as a diagram over time.

### DETAILED DESCRIPTION OF THE DRAWINGS

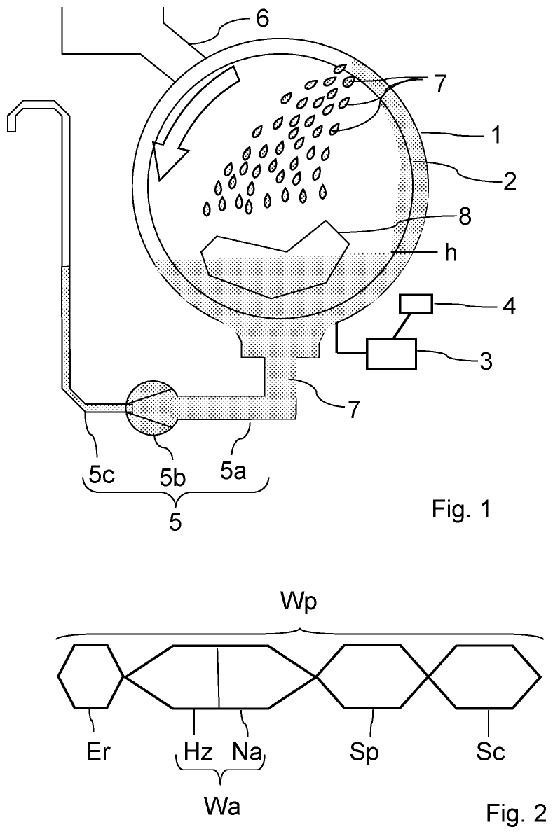

FIG. 1 is a partial cross-sectional view of a washing machine according to the disclosure. The washing machine has a suds container 1 for holding water 7, a non-ribbed drum 2 rotatably mounted in the suds container 1 for holding laundry 8, and a motor 3 for driving the drum 2. The washing machine also has a dispensing compartment 6 that can optionally contain a treatment agent such as washing powder and that is connected to the suds container 1 so that water 7 can be filled into the suds container 1 and into the drum 2 via said dispensing compartment. The drum 2 has a large number of drum openings (not shown) for circulation. The washing machine also has a drain device 5 in order to be able to remove the water 7 from the suds container 1. The drain device 5 has a drain pipe 5a that connects the suds container 1 to a drain pump 5b that in turn is connected to a drain line 5c that usually opens into a sewer. The washing machine also has an open or closed loop control device 4 that is designed to control the motor 3, a water inlet and outlet, the execution of a washing program and the like in an open or closed loop.

When the washing machine is in operation, a washing program shown in FIG. 2 is executed, for example. For example, in a rinsing step of the washing program, water 7 is supplied to the suds container 1 and to a first region of the drum 2, which corresponds to a position approximately between 5 and 7 o'clock, up to a predetermined water level h that is selected such that the laundry 8 floats in the water 7, and then the drum 2 is rotated at a predetermined rotational speed such that water 7 is released from a second region of the drum 2 and falls onto the laundry 8. In the rinsing step, in the case of the non-ribbed drum, at the predetermined water level h, the predetermined rotational speed is adjusted in particular in such a way that the water 7 is entrained in a gap between the suds container 1 and the drum 2 by the rotation of the drum 2 to an extent such that the water 7 is released drop-wise at about the 1 o'clock position (when the cross-sectional view of the drum 2 is viewed analogously to a clock) and falls onto the laundry 8. This is possible because there are no ribs in the drum 2, which, if present, cause the laundry 8 to execute a rotational motion. In addition, the water level h is selected such that the laundry 8 can float. As a result, friction between the drum casing and the laundry 8 is eliminated and the laundry 8 is not caused to execute a rotational motion by the rotation of the drum 2 but remains substantially in the same position.

FIG. 2 shows a washing program stored in the washing machine shown in FIG. 1 as a diagram over time. The individual phases within the washing program Wp are shown on the time axis t. The program sequence Wp shown herein comprises a detection phase Er, a washing phase Wa, a rinsing phase Sp, and a spin phase Sc. At the beginning of the washing program Wp, the batch of laundry is recorded in the detection phase Er in which a load amount of laundry in the drum is detected. Thereafter, water is let in via the dispensing compartment, as a result of which a treatment agent stored therein, such as washing powder, is filled into the suds container. In the washing phase Wa, a heating portion Hz then follows, in which the water is heated by means of a switched-on heating member of the washing machine to a temperature that is specified by the open or closed loop control device based on the selected washing program Wp. After the specified temperature has been reached, the heating member is switched off and a so-called post-wash portion Na follows. In this post-wash portion Na, the laundry is moved by means of a rotating drum, with the water cooling down. The washing phase Wa ends with the pumping out, with the drain device, in particular the drain pump, being activated. When draining, it is also possible to spin the laundry so that the water mixed with the treatment agent is removed from the laundry. This is followed by the rinsing phase Sp, in which water is again filled into the suds container and the laundry is moved therein in order to rinse the laundry. At the end of the rinsing phase Sp, the rinsing water is pumped out, followed by the final spin cycle Sc for draining water from the laundry. During the final spin cycle Sc, the drum is rotated at a higher speed than in the washing process, at which rotational speed the laundry lies in contact with the drum casing and the water is thrown out of the laundry through the drum openings due to the centrifugal force. The drain device is activated in this case, so that the water is removed from the suds container.

### LIST OF REFERENCE SIGNS

Er Detection phase
h Water level
Hz Heating phase
Na Post-wash phase
Sc Spin phase
Sp Rinsing phase
Wa Washing phase
Wp Washing program
1 Suds container
2 Drum
3 Motor
4 Open or closed loop control device
5 Drainage system
5a Drain pipe
5b Drain pump
5c Drain line
6 Dispensing compartment
7 Water
8 Laundry

1. A method for operating a washing machine having a suds container for holding water, a non-ribbed drum rotatably mounted in the suds container for holding laundry, a motor for driving the drum, and an open or closed loop control device, the method allowing the execution of a washing program (Wp) having a washing phase (Wa) and/or at least one rinsing phase (Sp), the method comprising the following steps:
a) feeding water into the suds container and a first region of the drum in at least one of the washing and rinsing phases (Wa, Sp) up to a predetermined water level (h) that is selected such that the laundry floats in the water; and
b) rotating the drum at a predetermined rotational speed such that water is released from a second region of the drum and falls onto the laundry.

2. The method according to claim 1, wherein the first region is a lower region and the second region is an upper region, based on an operational set-up position of the washing machine.

3. The method according to claim 1, wherein the drum is circular in cross section, the first region is a region of the drum between a 5 and a 7 o'clock position and the second region is a region of the drum between a 12 and 2 o'clock position and/or between a 10 and 12 o'clock position when viewed in the circular cross section.

4. The method according to claim 1, wherein steps a) and b) are executed in at least one of the at least one rinsing phase (Sp).

5. The method according to claim 1, wherein, before the execution of the washing phase and/or at least one rinsing phase (Wa, Sp), a detection phase (Er) is executed in which a load amount of laundry in the drum is detected, and wherein step b) is carried out as a function of the detected load amount.

6. The method according to claim 5, wherein step b) is executed if the load amount is below a predetermined limit value.

7. The method according to claim 6, wherein the predetermined limit value depends on a type of laundry which is determined by selecting the washing program (Wp).

8. The method according to claim 1, wherein the predetermined rotational speed is in the range of 70 and 180 rpm or 90 to 110 rpm.

9. A washing machine having a suds container for holding water, a non-ribbed drum rotatably mounted in the suds container for holding laundry, a motor for driving the drum, and an open or closed loop control device that is designed to carry out the method according to claim 1.

10. The washing machine according to claim 9, wherein it the washing machine is free of a circulation system.
